(19) United States
(12) Patent Application Publication
(10) Pub. No.: US 2011/0025624 A1
(43) Pub. Date: Feb. 3, 2011

(54) Image Display Device

(75) Inventor: Koji GOTO, Osaka (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/837,396

(22) Filed: Jul. 15, 2010

(30) Foreign Application Priority Data
Jul. 29, 2009 (JP) 2009-176402

(51) Int. Cl. G06F 3/041

(52) U.S. Cl. 345/173

(57) ABSTRACT

A method for operating an image display device for resizing an image on a touch panel is disclosed. The method displays an image, and detects an image resizing instruction set for changing a size of the image on the touch panel. The method changes the size of the image on the touch panel based on the image resizing instruction set. In this manner, a user can change the size of the image on the touch panel without inadvertently terminating an image resizing process.

### CROSS-REFERENCE TO RELATED APPLICATION

The present application claims priority under 35 U.S.C. §119 to Japanese Patent Application No. 2009-176402, filed on Jul. 29, 2009, entitled “IMAGE DISPLAY DEVICE”. The content of which is incorporated by reference herein in its entirety.

### FIELD

Embodiments of the present disclosure relate generally to image display devices, and more particularly relate to an image display device comprising a touch panel operable to enlarge/reduce an image on the touch panel.

### BACKGROUND

There are electronic devices comprising a touch panel in which, an image displayed on the touch panel can be enlarged by an image enlargement process. The image enlargement process may comprise pressing/activating an Enlarge switch and touching the image displayed on the touch panel. The image enlargement process may be terminated when the Enlarge switch is pressed again. For example, after pressing the Enlarge switch, a user may become absorbed in an activity unrelated to operating the device (e.g., conversations with others) and forget he/she pressed the Enlarge switch. This may lead him/her to press the Enlarge switch again and unintentionally terminate the enlargement process.

### SUMMARY

A method for operating an image display device for resizing an image on a touch panel is disclosed. The method displays an image, and detects an image resizing instruction set (i.e., a key activation in a touch state) for changing a size of the image on the touch panel. The method change the size of the image on the touch panel based on the image resizing instruction set. In this manner, a user can change the size of the image on the touch panel without inadvertently terminating an image resizing process.

In a first embodiment, an image display device comprises one or more manipulation keys comprising a first key, a touch panel operable to display a displayed image, and a detection module operable to detect a touch state of the touch panel. The image display device further comprises a control module operable to perform an image sizing operation to change a size of the displayed image on the touch panel, if the first key is activated in the touch state.

A second embodiment comprises a method for operating an image display device. The method comprises displaying a displayed image on a touch panel, detecting an image resizing instruction set, and changing a size of the displayed image on the touch panel based on the image resizing instruction set.

A third embodiment comprises a computer-readable medium comprising program code for operating an image display device. The program code comprises displaying a displayed image on a touch panel, detecting an image resizing instruction, and changing a size of the displayed image on the touch panel based on the image resizing instruction.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1A is an illustration of an open state of an exemplary mobile phone according to an embodiment of the present disclosure.

FIGS. 1B and 1C are illustrations of an attempt to enlarge an image using the exemplary mobile phone shown in FIG. 1A according to an embodiment of the present disclosure.

FIG. 2 is an illustration of a schematic functional block diagram of an exemplary mobile phone according to an embodiment of the disclosure.

FIG. 3 is a flowchart showing an exemplary process of image enlargement and reduction according to an embodiment of the present disclosure.

FIG. 4A is an illustration of an exemplary image displayed at an optimal size on a touch panel according to an embodiment of the present disclosure.

FIG. 4B is an illustration of an exemplary enlarged image shown in FIG. 4A displayed on the touch panel.

FIG. 4C is an illustration of an exemplary enlarged image as shown in FIG. 4B.

FIG. 4D is an illustration of the enlarged image as shown in FIG. 4C.

FIG. 5A is an illustration of an exemplary mobile phone with a manipulation key comprising a see-saw manipulation key according to an embodiment of the present disclosure.

FIG. 5B is an illustration of an exemplary mobile phone comprising a manipulation key comprising a see-saw manipulation key where an upper part of the see-saw manipulation key is held down according to an embodiment of the present disclosure.

FIG. 5C is an illustration of an exemplary mobile phone comprising a manipulation key comprising a see-saw manipulation key where a lower part of the see-saw manipulation key is held down according to an embodiment of the present disclosure.

FIG. 6A is an illustration of an exemplary mobile phone comprising a manipulation key comprising a sliding manipulation key according to an embodiment of the present disclosure.

FIG. 6B is an illustration of an exemplary mobile phone comprising a manipulation key comprising a sliding manipulation key, showing a direction of an operation of the sliding manipulation key according to an embodiment of the present disclosure.

FIG. 7A is an illustration of a top view of an exemplary mobile phone comprising a touch panel displaying an exemplary image according to an embodiment of the present disclosure.

FIG. 7B is an illustration of a top view of an exemplary mobile phone touched by a user on a ZOOM IN key according to an embodiment of the present disclosure.

FIG. 7C is an illustration of a top view of an exemplary mobile phone comprising a touch panel displaying an enlarged image shown in FIG. 7A.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding technical field, background, brief summary or the following detailed description. The present disclosure should be accorded scope consistent with the claims, and not limited to the examples described and shown herein.

Embodiments of the disclosure are described herein in the context of one practical non-limiting application, namely, an information processing device such as a mobile phone. Embodiments of the disclosure, however, are not limited to such mobile phone, and the techniques described herein may also be utilized in other applications. For example, embodiments may be applicable to digital books, digital cameras, electronic game machines, digital music players, personal digital assistance (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

To enlarge an image displayed on a touch panel of some devices, an Enlarge switch may be pressed and then an image displayed on the touch panel is touched and enlarged. The image enlargement process may be terminated when the Enlarge switch is pressed again. This image resizing operation may not be optimal. Because, after pressing the Enlarge switch, the user may be distracted by an activity unrelated to operating the device such as conversations with others and may forget that she/he has already pressed the Enlarge switch. This may lead the user to press the Enlarge switch again and terminate the enlargement process already in progress. Embodiments of the disclosure provide instruction means for changing a size of the image on the touch panel thereby preventing the user inadvertently to terminate an image resizing process.

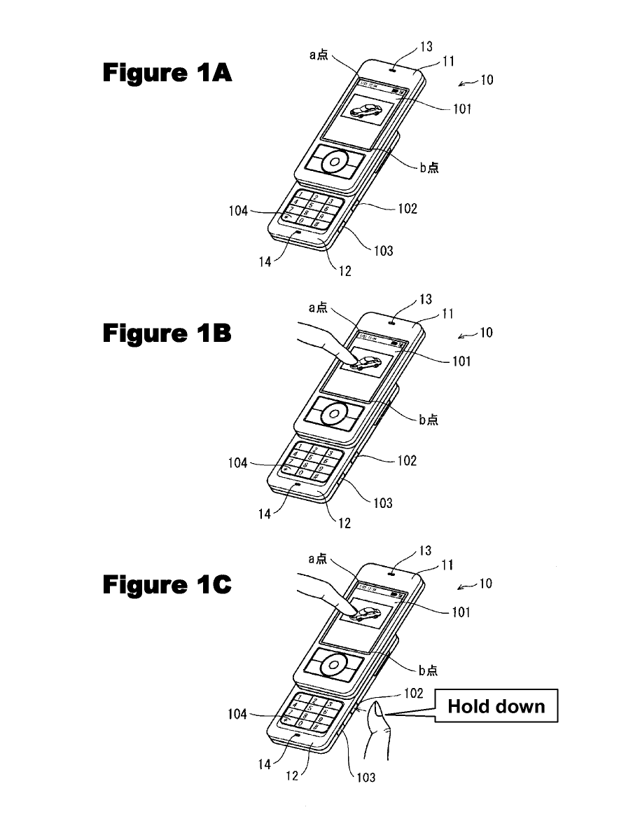

FIG. 1A is an illustration of an exemplary mobile phone 10 according to an embodiment of the disclosure.

The mobile phone 10 may be, for example but without limitation, a sliding type in which a first chassis and a second chassis can slide in one direction from a state where the first chassis and the second chassis are overlapped; a folding type comprising a first chassis (manipulation-side chassis), a second chassis (display-side chassis) and a coupling portion coupling the chassis; a turning type in which one of the first chassis or the second chassis is made to turn around an axis line along an overlapping direction of a first chassis and a second chassis; a straight type in which the first chassis and the second chassis are arranged in one chassis comprising no coupling portion; and the like.

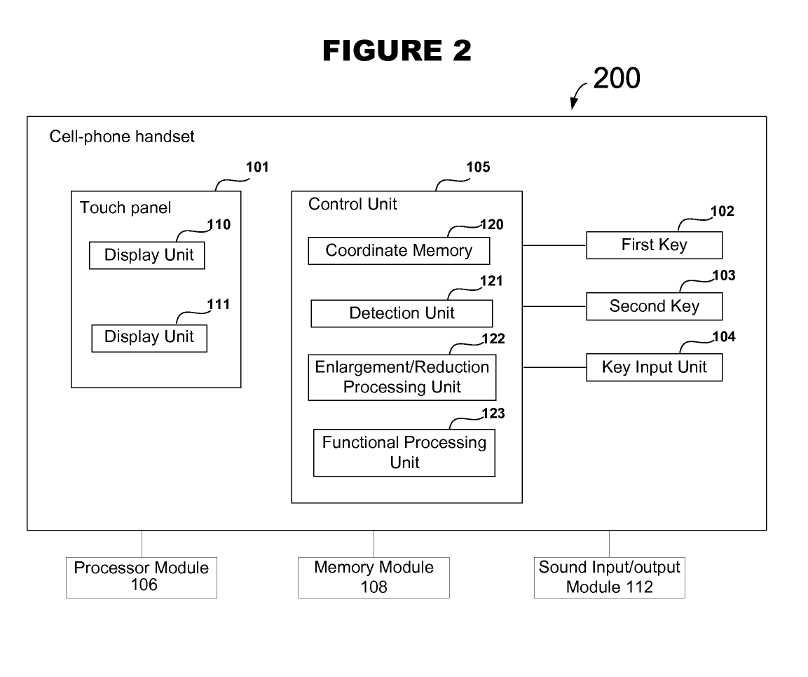

The mobile phone 10 may comprise a first chassis 11, and a second chassis 12. The first chassis 11 may comprise a speaker 13 and a touch panel 101 as explained in more detail in the context of discussion of FIG. 2. The second chassis may comprise a microphone 14, a key manipulation module 104, a first manipulation key 102 and/or a second manipulation key 103 as explained in more detail in the context of discussion of FIG. 2. A plurality of images can be displayed on the touch panel 101. The user can cause the mobile phone 10 to perform various operations by touching each of the images with their finger, a stylus, or the like. For example, the user can cause the mobile phone 10 to enlarge and reduce the images displayed on the touch panel 10 as explained in more detail below. In this document, images are not limited to images taken with a digital camera. The images may also be downloaded from a browser, or the like. Moreover, if multiple images (image group) are displayed on the touch panel 101, the image group is handled as a single image. In FIG. 1A, an image taken is displayed on the touch panel 101. FIGS. 1B and 1C illustrate an attempt to enlarge the image.

As shown in FIG. 1B, the user touches the image displayed (touch state) on the touch panel 101 with her/his finger in this example.

As shown in FIG. 1C, by holding down a first manipulation key 102 while in the touch state (FIG. 1B), the displayed image can be enlarged.

By holding down (not shown) a second manipulation key 103 while in the touch state, the displayed image can be reduced.

FIG. 2 is an illustration of a schematic functional block diagram of a mobile phone 200 according to an embodiment of the disclosure.

The mobile phone 200 may comprise the touch panel 101, a first manipulation key 102, a second manipulation key 103, a key input module 104, a control module 105, a processor module 106, a memory module 108, and a sound input/output module 112.

The touch panel 101 comprises a display module 110, and an input module 111. The display module 110 comprises a Liquid Crystal Display (LCD) operable to display images. For example, the display screen of the display module 110 may be formed by an organic electro-luminescence (OEL) panel. Various kinds of information can be displayed on the display module 110 of the touch panel 101 via an image/video signal supplied from the control module 105. For example, an image or a group images can be displayed on a display screen of the display module 110 as described in more detailed below. A pixel count (width×height) of the LCD may be, for example but without limitation, about 150×300 pixels, or the like.

The input module 111 detects touch operations performed by the user. During detection of the touch operation, the input module 111 sends coordinate values (x, y) of a position of a touch per predetermined time (e.g., once per 60 seconds) to the control module 105. For example, the input module 111 sends, to the control module 105, coordinate values (0, 0) when point “a” in FIG. 1A at a top left corner of the LCD of the touch panel 101 is touched, or coordinate values (150, 300) when point “b” at a bottom right corner of the LCD of the touch panel 101 is touched. The input module 111 may be, for example but without limitation, a resistance film system, an optical system (infrared system), an electrostatic capacitor coupling system, or the like.

The first manipulation key 102 and the second manipulation key 103 transmit operational instructions from the user by sending signals to the control module 105 indicating that the manipulation key is being held down. By holding down/activating the first manipulation key 102 or the second manipulation key 103, the user transmits operational instructions to the mobile phone 200/10.

The key input module 104 comprises keys suitable for operating the mobile phone 10/200, such as a number pad and directional keys (FIG. 1A). These keys transmit operational instructions from the user by sending signals to the control module 105 indicating that the key is being held down. By holding down/activating the keys according to operations conducted on the mobile phone 200/10, the user transmits operational instructions to the mobile phone 200/10. The control module 105 controls image resize processing of the mobile phone 200.

The control module 105 comprises a coordinate memory module 120, a detection module 121, an enlargement/reduction processing module 122, and a functional processing module 123.

The coordinate memory module 120 stores coordinate values sent from the input module 111. In practical embodiments, the coordinate memory module 120 may comprise, for example but without limitation, a non-volatile storage device (non-volatile semiconductor memory, hard disk device, optical disk device, and the like), a random access storage device (for example, SRAM, DRAM), or any other form of storage medium known in the art.

The detection module 121 detects whether the user is touching the touch panel 101 by receiving coordinate values from the input module 111. The detection module 121 also detects whether the first manipulation key 102, the second manipulation key 103, or the key input module 104 is activated.

For example, if coordinate values are received from the input module 111, the detection module 121 detects that the touch panel 101 is in a touched state, whereas if coordinate values are not received, the detection module 121 detects that the panel is not in a touched state (i.e., in a “detached state”).

Based on the presence or absence of signals output to the control module 105 when the first manipulation key 102, the second manipulation key 103, or a key comprised in the key input module 104 is held down (operated), the detection module 121 detects whether these keys are being activated.

Based on coordinate values stored in the coordinate memory module 120, the enlargement/reduction processing module 122 performs enlargement and reduction processes for an image being displayed. Image enlargement and reduction processes based on coordinate values refer to enlargement and reduction using the coordinate values as the center. Therefore, the part of the image displayed at the location touched (touch location) by the user does not shift to another position due to enlargement or reduction. When the image being displayed is not fully displayed on the touch panel 101, the user touches her/his finger, or the like, to the position she/he would like to move the image on the touch panel 101 and, without breaking contact with the touch panel 101, the user slides the finger in the direction she/he would like to move the displayed image, and the enlargement/reduction processing module 122 changes the displayed position of the image being displayed.

The image enlargement and reduction process is described below.

When the detection module 121 detects an image resizing instruction set/an image resizing instruction such as detecting a touch state together with detecting that the first manipulation key 102 is activated (pressed/held down), the enlargement/reduction processing module 122 performs an enlargement process of the displayed image based on the coordinate values stored in the coordinate memory module 120. Then, the enlargement/reduction processing module 122 may enlarge the displayed image by a prescribed scale factor (e.g., ×1.2) each time the first manipulation key 102 is held down and display the enlarged image. The display color displayed at the location touched by the user does not change. When the size of the enlarged image reaches a predetermined maximum size, the enlargement/reduction processing module 122 subsequently does not perform the enlargement process even if the first manipulation key 102 is held down.

When the detection module 121 detects a touched state and also detects that the second manipulation key 103 is being operated (held down), the enlargement/reduction processing module 122 performs a reduction process of the displayed image based on the coordinate values stored in the coordinate memory module 120. At this time, the enlargement/reduction processing module 122 may reduce the displayed image by a prescribed reduction scale factor (e.g., ×0.8) each time the second manipulation key 103 is held down and display the reduced image. The display color displayed at the location touched by the user does not change. Depending on the reduction scale factor, the display color of the pixel indicated by the coordinate value may be combined with the display color adjacent to this pixel and displayed in the pixel indicated by the coordinate position. When the size of the reduced image is reached a predetermined optimal size, the enlargement/reduction processing module 122 subsequently determines whether the entirety of the reduced image is displayed on the touch panel 101. If the enlargement/reduction processing module 122 determines that the entirety of the image is displayed on the touch panel 101, the enlargement/reduction processing module 122 does not perform the reduction process. If the enlargement/reduction processing module 122 determines that the entirety of the reduced image is not displayed on the touch panel 101, the enlargement/reduction processing module 122 performs the reduction process. The determination by the enlargement/reduction processing module 122 as to whether the entirety of the reduced image is displayed on the touch panel 101 may be realized by comparing the size of the image being displayed and the screen size.

The optimal size may be the initial size when the image is displayed (i.e., the size before the enlargement process is performed).

Moreover, the optimal size may be the size in which the entirety of the image being displayed is displayed on the touch panel 101.

In the enlargement and reduction processes, if margins are formed on the screen of the touch panel 101 when displaying the image, the margins may be displayed with a default color.

The functional processing module 123 may perform processes related to functions for operations of each of the first manipulation key 102, the second manipulation key 103, and the key input module 104. Operations of the mobile phone 10 may also be assigned to the first manipulation key 102 and the second manipulation key 103.

Specifically, when the detection module 121 does not detect a touched state and detects that any of the first manipulation key 102, the second manipulation key 103, or a key comprised in the key input module 104 is being operated (held down), the functional processing module 123 performed a functional operation based on operational instructions provided by the user through the key operation. For example but without limitation, operations for raising the volume are assigned to the first manipulation key 102, and operations for lowering the volume are assigned to the second manipulation key 103. In this case, because the first manipulation key 102 or the second manipulation key 103 is held down while the panel is in a detached state, operations for raising or lowering the volume are performed.

The processor module 106 may comprise transmission/reception of signals at the mobile phone 10. The processor module 106 controls overall operation of the mobile phone 10. For example, the processor module 106 may control operations of the mobile phone 10 so that processes of the mobile phone 10 are suitably performed such that various processing are performed by proper procedures in response to manipulation of the manipulation module 104. These processes comprise, for example but without limitation, receiving an image resizing instruction/instruction set such as activation of a first key in touch state, and the like, exerting a telephone call function, activating electronic mail, browsing a website, downloading images, and the like. The processor module 106 also controls a communication of the mobile phone 10, access to the coordinate memory module 120 to access coordinate values of the touch panel 101, image display on the display module 110, voice processing of the sound input/output module 112, and the like. For example, the processor module 106 can control the display module 110 to display images on a screen of the display module 110 of the touch panel 101 when performing an image sizing/resizing operation.

The processor module 106 may comprise a computer (microprocessor) or another processor for performing a process based on a program (operating system, application program, etc.) stored in the memory module 108. The processor module 106 may read instruction code sequentially from programs such as the operating system and the application program, which are stored in the memory module 108, and perform the programs. For example, the image sizing/resizing operation in the processor module 106 may be realized on the computer by one or a plurality of programs, or may be at least partially realized by hardware.

The memory module 108 is operable to store various kinds of data used for various processes of the mobile phone 10. In practical embodiments, the memory module 108 may comprise, for example but without limitation, a non-volatile storage device (non-volatile semiconductor memory, hard disk device, optical disk device, and the like), a random access storage device (for example, SRAM, DRAM), or any other form of storage medium known in the art. For example, the memory module 108 may store, coordinates values of the touch panel 101, various images, a computer program that is executed by the processor module 106, an operating system, an application program, tentative data used in executing a program processing, and the like. The memory module 108 may be coupled to the processor module 106 such that the processor module 106 can read information from and write information to memory module 108. As an example, the processor module 106 and memory module 108 may reside in their respective ASICs. The memory module 108 may also be integrated into the processor module 106. In an embodiment, the memory module 108 may comprise a cache memory for storing temporary variables or other intermediate information during execution of instructions to be executed by the processor module 106. The memory module 108 may also comprise non-volatile memory for storing instructions to be executed by the processor module 106.

The sound input/output module 112 carries out a process for outputting a voice signal output from the speaker 12 and receiving a voice signal input from a microphone 14. In this manner, the sound input/output module 112 amplifies the analog voice input from the microphone 14, and carries out an analog/digital conversion to obtain a digital voice input. The sound input/output module 112 applies a signal processing such as an encoding or the like to the digital voice input to obtain an encoded digital voice input, and sends the encoded digital voice input to the processor module 106. The sound input/output module 112 is also operable to apply a signal processing to a digital voice data supplied from the processor module 106. In this manner, the sound input/output module 112 performs decoding, digital/analog conversion, and amplification to convert the digital voice data to an analog voice signal for output to the speaker 12.

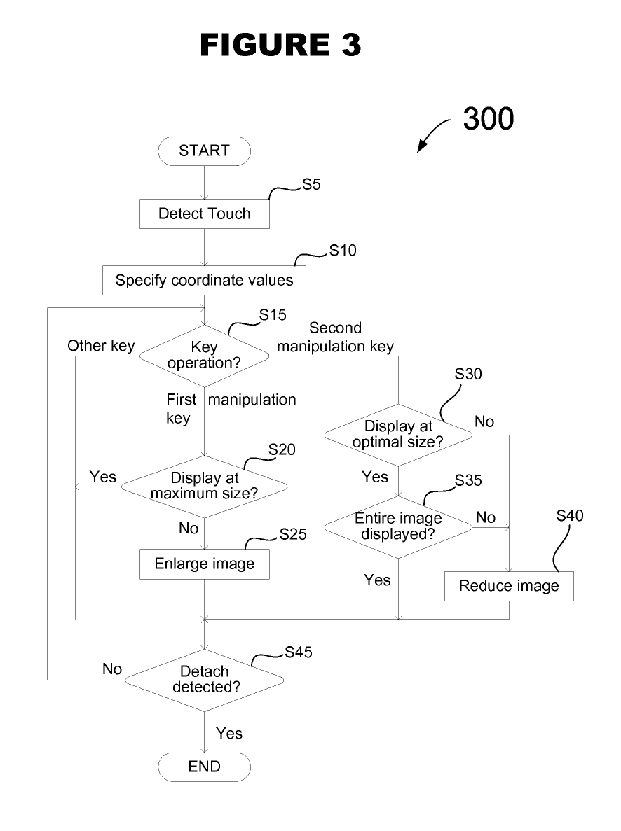

FIG. 3 is a flowchart showing an exemplary process 300 for image enlargement and reduction suitable for use with the mobile phone 10/200 according to according to an embodiment of the disclosure. The various tasks performed in connection with process 300 may be performed by software, hardware, firmware, a computer-readable medium having computer executable instructions for performing the process method, or any combination thereof. The process 300 may be recorded in a computer-readable medium such as a semiconductor memory, a magnetic disk, an optical disk, and the like, and can be accessed and executed, for example, by a computer CPU in which the computer-readable medium is stored. It should be appreciated that processes 300 may comprise any number of additional or alternative tasks, the tasks shown in FIG. 3 need not be performed in the illustrated order, and process 300 may be incorporated into a more comprehensive procedure or process having additional functionality not described in detail herein. For illustrative purposes, the following description of process 300 may refer to elements mentioned above in connection with FIGS. 1 to 2. In practical embodiments, portions of process 300 may be performed by different elements of the mobile phone 10/200 for sizing/resizing an image, e.g., the touch panel 101, the control module 105, the manipulation keys 102-103, etc. Process 300 may have functions, material, and structures that are similar to the embodiments shown in FIGS. 1 to 2. Therefore common features, functions, and elements may not be redundantly described here.

When the input module 111 detects a touch operation by the user (task S5), it specifies the coordinate values of the position being touched (task S10). The input module 111 sends the specified coordinate values to the control module 105. Upon receiving the coordinate values from the input module 111, the control module 105 stores the received coordinate values in the coordinate memory module 120. The detection module 121 detects that the panel is in a touch state.

During the touch detection of task S5 by the detection module 121 (i.e., while the detection module 121 is detecting the touch state), the enlargement/reduction processing module 122 determines whether the detection module 121 has detected a key operation (inquiry task S15).

Instead of a key operation, the mobile phone 10 may use a voice recognition function. For example, when an instruction such as “enlarge” or “reduce” is input from the microphone 14, the sound input/output module 112 converts the voice signal into an electrical signal and transmits the voice signal to the detection module 121 via the functional processing module 123. The detection module 121 detects the received signal as indicating a state in which a manipulation key has been pressed/activated, and the process can proceed in the same manner as when the first manipulation key or the second manipulation key is pressed/activate in inquiry task S15.

If process 300 determines that the detection module 121 has detected an activation of the first manipulation key 102 (“first manipulation key” in the inquiry task S15), the enlargement/reduction processing module 122 determines whether the image currently being displayed is being displayed at a substantially maximum size (task S20).

If process 300 determines that the image is not being displayed at the substantially maximum size (“No” branch of injury task S20), the enlargement/reduction processing module 122 performs an enlargement process based on the coordinate values stored in the coordinate memory module 120 (task S25).

The detection module 121 detects whether the touch panel is in a detached state (inquiry task S45). If the detection module 121 detects that the touch panel 101 is in a detached state (“Yes” branch of inquiry task S45), the process 300 is terminated. If the detection module 121 detects that the touch panel 101 is not in a detached state (“No” branch of inquiry task S45), the process 300 leads back to the inquiry task S15.

If process 300 detects that the image is being displayed at a substantially maximum size (“Yes” branch of task S20), the process 300 proceeds to enlarge the image (task S45).

If the process 300 determines that the detection module 121 has detected an operation of the second manipulation key 103 (“second manipulation key” branch of inquiry task S15), the enlargement/reduction processing module 122 determines whether the image currently being displayed is being displayed at an optimal size (inquiry task S30).

If the enlargement/reduction processing module 122 determines that the image is not being displayed at the optimal size (“No” branch of in inquiry task S30), the enlargement/reduction processing module 122 performs a reduction process based on the coordinate values stored in the coordinate memory module 120 (task S40), and subsequently, the process 300 proceeds to the inquiry task S45 explained above.

If the enlargement/reduction processing module 122 determines that the image is being displayed at the optimal size (“Yes” branch of inquiry task S30), the enlargement/reduction processing module 122 determines whether the entire image is being displayed (inquiry task S35).

If the enlargement/reduction processing module 122 determines that the entire image is not being displayed (“No” branch of inquiry task S35), the enlargement/reduction processing module 122 performs a reduction process based on the coordinate values stored in the coordinate memory module 120 (task S40). Subsequently, the process 300 continues to the inquiry task S45 explained above.

If the enlargement/reduction processing module 122 determines that the entire image is being displayed (“Yes” branch of inquiry task S35), the process 300 continues to the inquiry task S45 explained above.

If process 300 determines that the detection module 121 has detected a key operation/activation in the key input module 104 (“Other key” branch of inquiry task S15), the process 300 continues to the inquiry task S45 explained above.

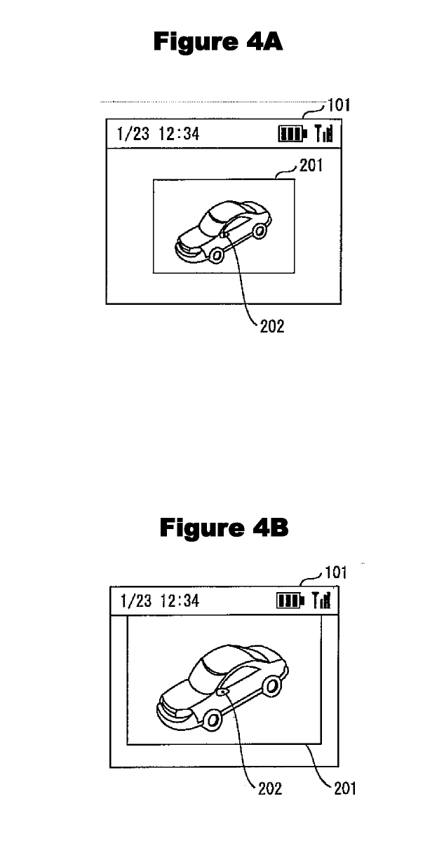

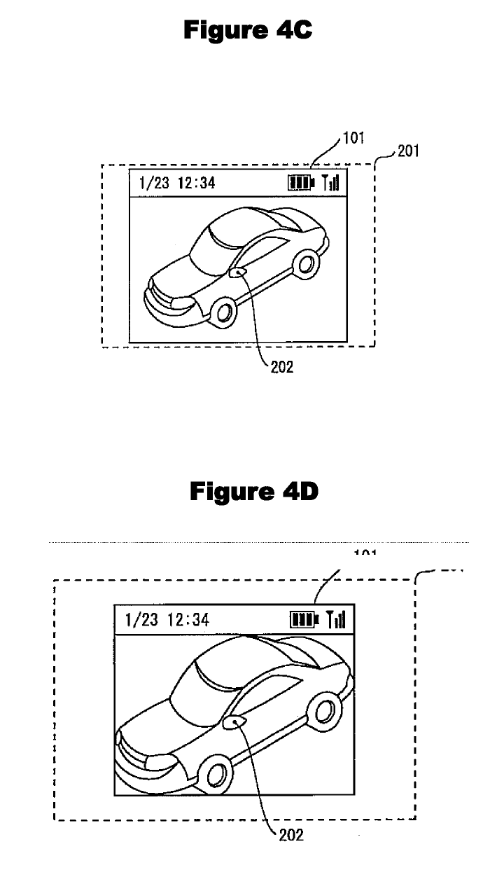

Image enlargement and reduction is explained in more detail below with reference to FIGS. 4A to 4D.

In FIG. 4A, a single image 201 taken with a digital camera is displayed at an optimal size on the touch panel 101. When the image 201 is being displayed, if the first manipulation key 102 is held down while touching coordinate values 202, an enlargement process is performed. As a result, the image 201 is enlarged as shown in FIG. 4B. Subsequently, each time the first manipulation key 102 is held down while touching the coordinate values 202, the enlargement process is performed and the image 201 is enlarged as shown in FIGS. 4C and 4D. The area indicated by dotted lines in FIGS. 4C and 4D is the size of the enlarged image and is larger than the screen size of the touch panel 101. For example, if the image size shown in FIG. 4D is substantially the maximum size, the enlargement process is subsequently not performed even when the first manipulation key 102 is held down while touching the coordinate values 202.

A transition of the displayed image in the reduction process is the reverse of the transition during enlargement. When the second manipulation key 102 is held down while touching the coordinate values 202 to perform the reduction process for the image 201 shown in FIG. 4D, the image 201 is reduced as shown in FIG. 4C. Subsequently, each time the second manipulation key 103 is held down while touching the coordinate values 202, the reduction process is performed and the image 201 is reduced in the order of FIGS. 4B to 4A. Because the size of the image 201 shown in FIG. 4A is the optimal size, the reduction process is subsequently not performed even when the second manipulation key 103 is held down while touching the coordinate values 202.

In the above description, one image was used as an example. However, the present disclosure is not limited to one image. Similar process may be performed when multiple images, such as thumbnails, are displayed on a single screen. Specifically, when multiple images are being displayed, expansion and reduction may be performed with the location being touched as a center of the displayed image.

Enlargement or reduction may be performed during a period in which the first manipulation key 102 or the second manipulation key 103 is held down while keeping the touch panel 101 in a touched state. Alternatively, a key in the key input module 104 may be used, such as but without limitation, an alpha numeric key, symbol key, character key, or the like.

Moreover, the first manipulation key 102 and the second manipulation key 103 that receive instructions for image expansion and reduction may be comprised in a first chassis 11 instead of a second chassis 12.

Once an image being expanded or reduced is displayed at the substantially maximum size or a substantially minimum size, instead of preventing image expansion or reduction, the mobile phone 10 may display the image at a prescribed size.

Once the image is displayed at the substantially maximum size or the substantially minimum size, when there is an instruction for further expansion or reduction, the image may be displayed using the size at which it was first displayed, or the image may be displayed at a specified size. That is, once the image is displayed at the substantially maximum size or the substantially minimum size, when there is an instruction for further expansion or reduction, the image may be displayed at a prescribed size.

As explained above, image expansion and reduction is performed when individual manipulation keys corresponding to each process are held down respectively, but the present disclosure is not limited to this method.

Instead of operations performed using two manipulation keys (the first manipulation key 102 and the second manipulation key 103 in FIG. 1A), image expansion and reduction may be performed through operations of a single manipulation key.

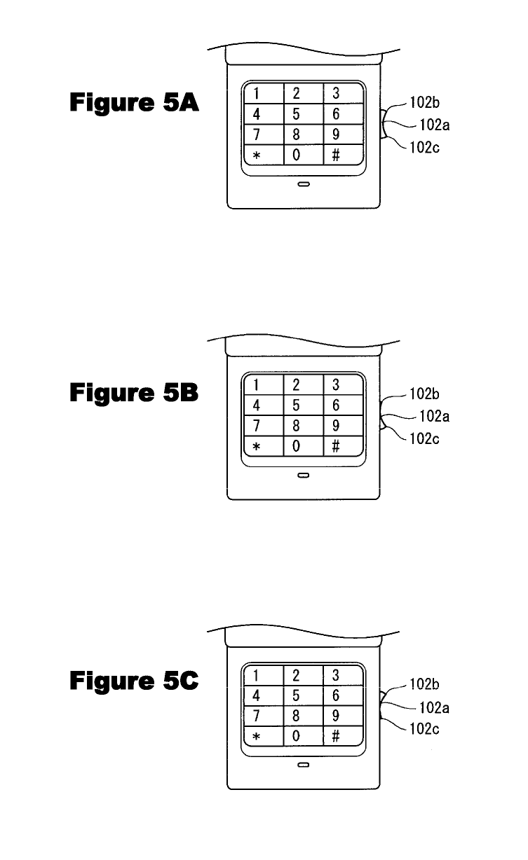

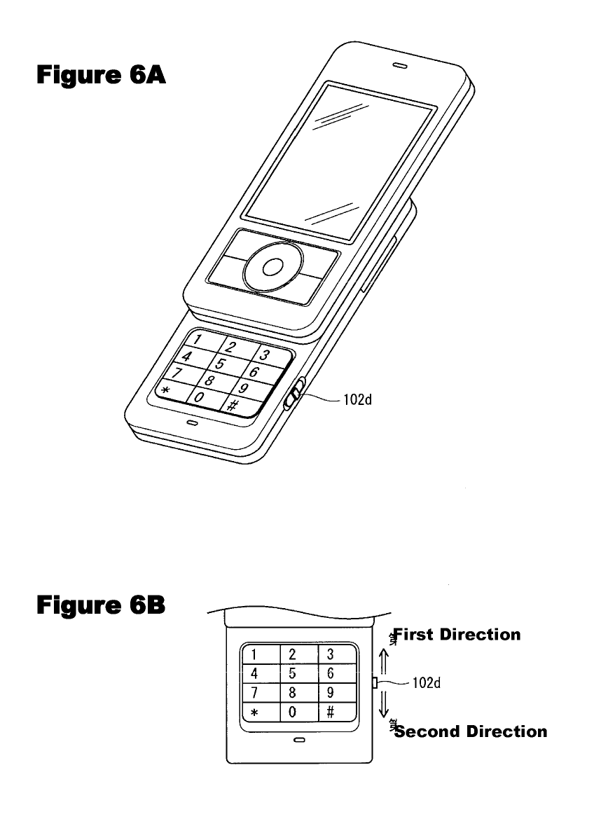

Examples of such a manipulation key comprise the see-saw manipulation key 102a shown in FIG. 5A and the sliding manipulation key 102d shown in FIG. 6A.

With the see-saw manipulation key 102a, when an end part 102b is held down (FIG. 5B) while touching the touch panel 101, for example, image enlargement is performed. Moreover, when an end part 102c is held down (FIG. 5C) while touching the touch panel 101, image reduction is performed.

With the sliding manipulation key 102d, sliding the manipulation key 102d in a first direction while touching the touch panel 101, for example, causes image expansion to be performed, while sliding the key in a second direction causes image reduction to be performed (FIG. 6B).

Methods for changing the display position of the image being displayed when the size of the image being displayed exceeds the screen size are not limited to the methods described above.

When the size of the image being displayed exceeds the screen size, scrollbars may be displayed in the vertical and/or horizontal directions, and the display position of the image being displayed may be changed by operating the displayed scrollbars. For example, the scrollbars are operated by touching a displayed scrollbar with a finger, or the like and, without breaking contact with the touch panel 101, sliding the finger in the direction for moving the scrollbar.

Information terminals can have two touch panels. The two touch panels may physically be two touch panels or may be a single touch panel divided into two for convenience. The following description is of a case in which a single touch panel is used by being divided into a first panel area and second panel area.

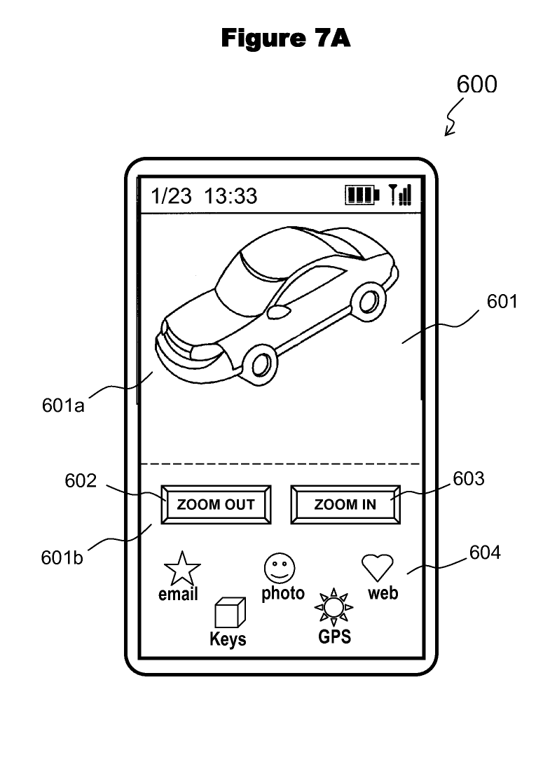

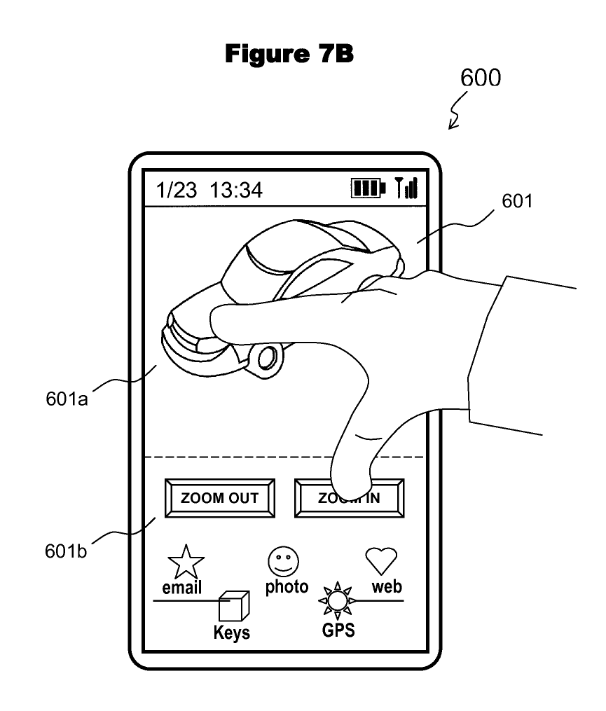

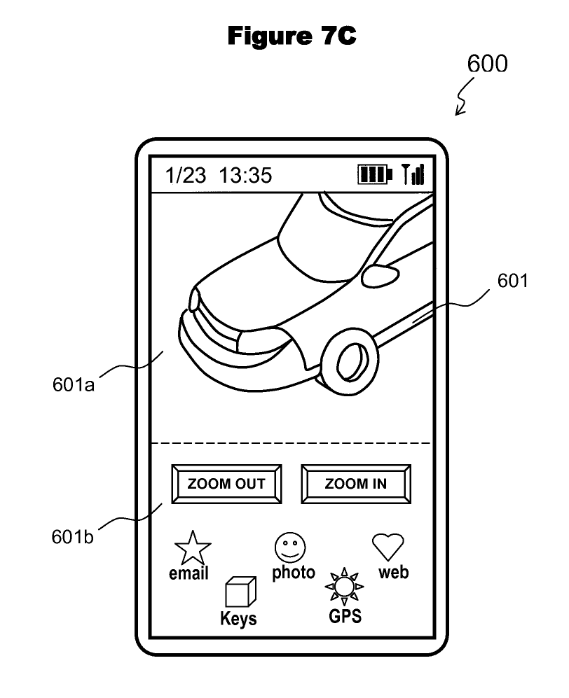

As the information terminal, a straight-type mobile phone 600 will be described. FIG. 7A is a top view of the mobile phone 600. The mobile phone 600 comprises a touch panel 601. The touch panel 601 comprises two areas: an image display area 601a and a key display area 601b.

The image display area 601a can display still images and videos. The key display area 601b can display one or multiple manipulation keys. In FIG. 7A, the key display area 601b has a ZOOM IN key 602 for enlarging images and a ZOOM OUT key 603 for reducing images. The key display area 601b also comprises an action key group 604 for activating other additional functions. In FIG. 7A, the action key group 604 comprises an Email key, a Photo key, a Web key, a Keys key, and a GPS key. Pressing the Email key activates an email function. Pressing the Phone key activates a telephone function. Pressing the Web key enables access to the Internet. Pressing the Photo key makes it possible to take photographs. Pressing the Keys key causes a keyboard display to appear in the display area. The keyboard may be a full keyboard or a simplified keyboard. Pressing the GPS key causes the current position to be displayed on a map.

In the embodiment shown in FIG. 7A, two or more touch panels are provided. In this manner, the image subject to enlargement and reduction is displayed on the first touch panel (image display area 601a), while a first touch area (ZOOM IN key 603) and a second touch area (ZOOM OUT key 602) are displayed on the second touch panel (key display area 601b). The ZOOM IN key 603, and ZOOM OUT key 602 correspond to the first manipulation key 102 and the second manipulation key 103 of FIGS. 1A to 1C respectively. In this case, image enlargement and reduction can be performed by holding down the first touch area or the second touch area on the second touch panel while touching the image on the first touch panel.

Specifically, as shown in FIG. 7B, the user presses/activates/touches the ZOOM IN key 603 of the key display area 601b with her/his right thumb while pressing (touching) part of the image (i.e., the front of the car) displayed in the image display area 601a with their right forefinger. As a result, as shown in FIG. 7C, the image is enlarged in the image display area 601a with the location being touched by the user's forefinger as the center of the displayed image.

Instead of having the touched location as the center, the image being enlarged by pressing the ZOOM IN key 603 may be enlarged or reduced based on a central position of the touch panel 601. Alternatively, display color of the touched location (coordinate values) may be moved to the central position of the touch panel 601 and enlargement and reduction may be performed based on the central position.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

The above description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although FIGS. 1A to 7C depict example arrangements of elements, additional intervening elements, devices, features, or components may be present in an embodiment of the disclosure.

In this document, the terms “computer program product”, “computer-readable medium”, and the like may be used generally to refer to media such as, for example, memory, storage devices, or storage unit. These and other forms of computer-readable media may be involved in storing one or more instructions for use by the control module 105 to cause the control module 105 to perform specified operations. Such instructions, generally referred to as “computer program code” or “program code” (which may be grouped in the form of computer programs or other groupings), when executed, enable the image resizing method of the mobile phone 10/200.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. An image display device comprising:
one or more manipulation keys comprising a first key;
a touch panel operable to display a displayed image;
a detection module operable to detect a touch state of the displayed image of the touch panel; and
a control module operable to perform an image sizing operation to change a size of the displayed image on the touch panel, if the first key is activated in the touch state.

2. The image display device according to claim 1, wherein:
the first key is operable to enlarge the displayed image in the touch state; and
the manipulation keys further comprise a second key operable to reduce the displayed image in the touch state.

3. The image display device according to claim 1, wherein the detection module is further operable to detect whether the first key is activated in the touch state.

4. The image display device according to claim 3, wherein the detection module is further operable to:
detect the touch state, if coordinate values of a touch location are received therein; and
detect a detached state, if the coordinate values of the touch location are not received therein.

5. The image display device according to claim 1, wherein:
the touch panel is further operable to specify a touch location thereon, and
the control module is further operable to use the touch location as a fixed position during changing the size of the displayed image.

6. The image display device according to claim 5, wherein:
the touch panel is operable to specify the coordinate values of the touch location; and
the control module is further operable to enlarge and reduce the displayed image using the coordinate values as a center of the displayed image.

7. The image display device according to claim 5, wherein the control module is further operable to terminate changing the size of the displayed image when the displayed image is displayed on the touch panel in its entirety.

8. The image display device according to claim 1, wherein the control module is further operable to perform an operation other than the image sizing operation, if the first key is activated and the touch panel is not in the touch state.

9. A method for operating an image display device, the method comprising:
displaying a displayed image on a touch panel;
detecting an image resizing instruction set; and
changing a size of the displayed image on the touch panel based on the image resizing instruction set.

10. The method for operating an image display device according to claim 9, further comprising detecting a touch on the displayed image.

11. The method for operating an image display device according to claim 9, wherein the image resizing instruction set comprises activation of a first key in a touch state of the displayed image.

12. The method for operating an image display device according to claim 11, further comprising performing an operation other than the changing the size of the displayed image, if the first key is activated and the touch panel is not in the touch state.

13. The method for operating an image display device according to claim 12, further comprising:
enlarging the displayed image, if the first key is operated in the touch state; and
reducing the displayed image, if a second key is operated in the touch state.

14. The method for operating an image display device according to claim 9, further comprising:
specifying a touch location on the touch panel; and
using the touch location as a fixed position during the changing of the size of the displayed image.

15. The method for operating an image display device according to claim 9, wherein:
the touch panel is operable to specify coordinate values of the touch location; and
the control module is further operable to enlarge and reduce the displayed image using the coordinate values as a center of the displayed image.

16. The method for operating an image display device according to claim 15, further comprising:
detecting the touch state, if the coordinate values are received; and
detecting a detached state, if the coordinate values are not received.

17. The method for operating an image display device according to claim 9, further comprising terminating the changing of the size of the displayed image when the displayed image is displayed on the touch panel in its entirety.

18. A computer-readable medium comprising program code for operating an image display device, the program code for:
displaying a displayed image on a touch panel;
detecting an image resizing instruction; and
changing a size of the displayed image on the touch panel based on the image resizing instruction.

19. The computer-readable medium of claim 18, wherein the image resizing instruction comprises activation of a first key in a touch state of the displayed image.

20. The computer-readable medium of claim 19, further comprising performing an operation other than the changing of the size of the displayed image, if the first key is activated and the touch panel is not in the touch state.
